(19) United States
(12) Patent Application Publication
(10) Pub. No.: US 2011/0292657 A1
(43) Pub. Date: Dec. 1, 2011

(54) ELECTRIC FIRE

(76) Inventors: Martin Betz, Co. Louth (IE); Arthur Purton, Dublin (IE)

(21) Appl. No.: 13/140,146

(22) PCT Filed: Dec. 14, 2009
(86) PCT No.: PCT/EP2009/067126

§ 371 Date: Jul. 22, 2011

(30) Foreign Application Priority Data
Dec. 17, 2008 (GB) 0822966.8

(51) Int. Cl. F21V 33/00; F24C 7/00

(52) U.S. Cl. 362/268; 362/277

(57) ABSTRACT

An electric fire is described which include a flame effect generator provided forwardly of a screen and configured to provide for generation of flame effect on the screen.

### FIELD OF THE INVENTION

The present invention relates to electric fires and in particular to electric fires which include a flame effect provided forwardly of a screen and configured to provide for generation of flame effect on the screen.

### BACKGROUND

Electric fires are well known in the art. Such fires typically include a heating element in for example the form of a fan heater or the like and operably provide for the generation of heat. Such fires have traditionally been provided to replace real combustion fires.

As part of this replacement of the real fire it is known to provide electric fires with flame effect simulators which are usefully employed to generate flame effects within an interior of the electric fire such that a user gets the visual impression of a fire burning within the fire. Such flame effect simulators are typically combined with an artificial fuel bed which provides for a simulation of the combustible material that is employed within the electric fire.

With the development of central heating within a domestic environment it is known that the electric fire provides a focal point within the room where it is located and the necessity for the heating element of the fire is not as prevalent. It is therefore known that electric fires can be provided without heating elements and within the context of the present invention the term electric fire is used to describe those fires that both include and omit heating elements.

There are many ways to provide flame effects within a fire. One such method is described in EP1703211 which provides for the utilisation of a fluid filled container provided forwardly of a screen and located between a light source and the screen. Rotation of the container effects a corresponding movement of the fluid and this is used to affect the transmission of light from the light source through the container and onto the screen. Use of a refractor screen between the fluid filled container and the screen is described. The arrangement described is useful in generating a flicker effect which is visible on the screen. The use of liquid within the context of an electrical fire presents a number of potential problems. Specifically it is necessary to ensure that the liquid is retained within the container and questions arise about whether this is better done at manufacture or by the end user. It is important to ensure that the liquid does not leak. Furthermore the storage of liquid within a container for extended periods of time may present problems in contamination or discolouration of the liquid.

For these reasons and others, there are still problems that need to be addressed in the context of electrical fires.

### SUMMARY

These and other problems are addressed by an electric fire provided in accordance with the teaching of the present invention. Such a fire includes a housing providing support for a screen on which a flame pattern may be generated. The fire includes one or more moveable solid element(s) located forwardly of the screen and between the screen and a light source. The at least one solid element is coupled to a motor, activation of which effects movement of the solid element. As the solid element moves, it causes a break in the light being transmitted onto the screen, thereby causing flicker effects on the screen. The light transmitted through the solid element(s) is incident on a front portion of the screen and is visible to a person viewing the fire from the front of the fire.

The moveable solid element may comprise a moveable baffle having a plurality of slits provided therein. Desirably the baffle is rotatable and the rotation of the baffle effectively moves the slits in and out of the transmission path between the light source and the screen. When the slits occlude the light path there is a corresponding absence of light on the screen, when they are in the light path, the light generated by the light source may pass through the slits and onto the screen to generate a lighting effect on the screen. The periodic change in intensity of light incident on the screen creates flicker effects. Desirably the slits have a length and a width and are arranged on the baffle such that the length extends substantially transverse to the axis of rotation of the baffle. In this way the rotation of the baffle gradually increases and then decreases the intensity of light seen on the screen.

Desirably the moveable baffle is provided in a cylindrical configuration with the light source being provided within the cylinder. The light source could however be arranged outside the cylinder. Typically in such arrangements the light source will be arranged to extend along the longitudinal axis of the cylinder.

A mask may be provided between the moveable solid element and the screen, the mask having a flame template provided therein such that operably light passing through the mask will adopt the mask pattern to create a desired flame pattern, corresponding substantially with the pattern of the flame template.

One or more lenses may also or alternatively be provided between the moveable solid element and the screen so as to selectively focus light to specific regions of the screen to improve the illusion of the flame effect. By using a lens arrangement it is possible to selectively direct the light to generate individual flames of a flame pattern. In a preferred arrangement a plurality of lens are provided, each of the lenses being associated with an individual generated flame within the flame pattern.

The moveable solid element could also be a plurality of ribbons or other fabric that are mounted on a moveable mount which may be actuated by a motor. The motor will effect a corresponding movement of the ribbons which will cause flicker effects. In this exemplary arrangement of moveable ribbons, the motor could be used to power a blower which is then used to impart movement onto the ribbons.

In a further embodiment the moveable solid element could be a plurality of individual solid elements within a container. Examples of the type of moveable objects include at least partially translucent beads or glass bodies, strips of metal or other materials, whose movement within the container will effect a disruption of the light passing through the container. The retention of the moveable elements within the container means that any agitation of the elements will not result in the elements becoming loose within the fire housing. The agitation could be provided by having a stationary container and effecting movement of the solid elements in the container by a secondary agitator such as paddle or the like. In a further embodiment the movement of the moveable elements could be effected by having a moveable container, movement of which imparting a corresponding movement of the elements therein. By having the light from the light source incident on the at least one solid element prior to incidence on the screen, the movement of the at least one solid element will effect flicker effects on the screen, resultant from disruptions in the light in its path between the light source and the screen.

The fire may also include a fuel bed located to the front of the fire and forwardly of the screen. The screen may include an at least partially reflective surface. By providing an at least partially reflective screen, it is possible to mirror the fuel bed so as to give the impression that the flame pattern displayed on the flame generating screen originates from a mid portion of the fuel bed.

Accordingly the invention provides an electric fire according to claim 1. Advantageous embodiments are provided in the dependent claims. A fire in accordance with claim 28 is also provided.

These and other features of the present invention will be better understood with reference to the following drawings.

### BRIEF DESCRIPTION OF THE DRAWINGS

The present invention will now be described with reference to the accompanying drawings in which:

FIG. 1A is a section through a fire provided in accordance with the teaching of the present invention.

FIG. 1B is a front view of a portion of the flame generating means of FIG. 1.

FIG. 2 is a section through a fire provided in accordance with the teaching of the present invention.

FIG. 3 is a section through a fire provided in accordance with the teaching of the present invention.

FIG. 4 is a section through a fire provided in accordance with the teaching of the present invention.

### DETAILED DESCRIPTION OF THE DRAWINGS

Exemplary arrangements of a fire provided in accordance with the teaching of the present invention will be described hereinafter to assist with an understanding of the benefits of the present invention. Such a fire will be understood as being exemplary of the type of fire that could be provided and is not intended to limit the present invention to any one specific arrangement as modifications could be made to that described herein without departing from the scope of the invention.

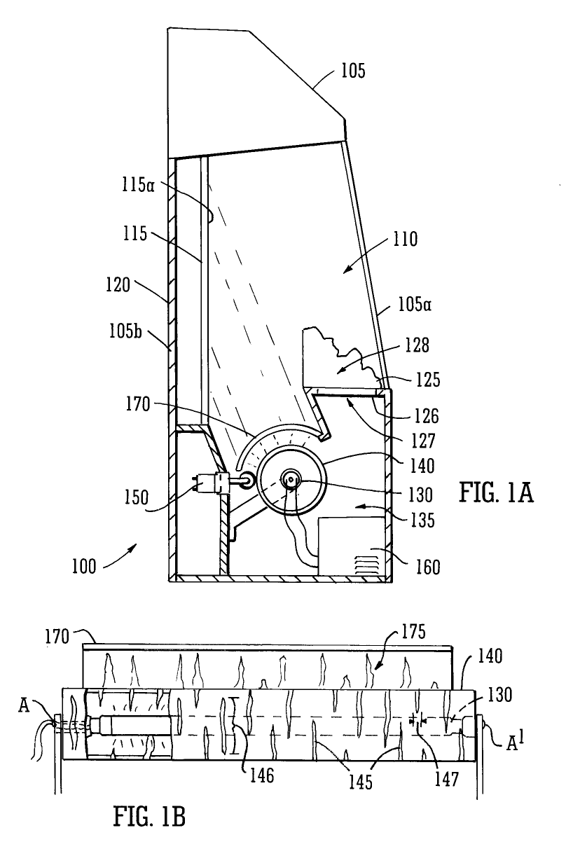

As shown in FIG. 1 a fire 100 includes a housing 105 which defines an interior volume 110. The housing has a front portion 105a and a rear portion 105b. Within the interior volume is supported a screen 115 onto which a flame pattern may be operably provided. On generation of a flame pattern a user of the fire located to the front of the fire will see the flame pattern on the screen. The screen 115 is typically located towards the rear 105b of the fire and may be parallel with, or as shown in FIG. 1, offset forwardly of a rear wall 120 of the housing 105.

Located towards the front of the fire at a level substantially coincident with the bottom of the screen 115 is provided a fuel bed 125. As shown in FIG. 1 the fuel bed 125 may be located on a supporting shelf 126 which may include an at least partially transparent surface 127. It will be appreciated that any supporting arrangement may be usefully employed. By providing an at least partially transparent surface 127 or indeed by providing a gap underneath the fuel bed 125, light below the fuel bed may be transmitted up into the fuel bed. If the fuel bed includes portions that are at least partially transparent or translucent then it will appear as if the fuel bed is internally illuminated.

A light source 130 is provided in a lower or bottom region 135 of the housing and may be used to illuminate the flame generating screen 115 and optionally the fuel bed 126. The light source 130 is coupled to a power supply 160. If used to illuminate the fuel bed, it will be appreciated that the use of the at least partially transparent surface 127 will operably allow light generated by the light source to pass upwardly into the fuel bed and to illuminate an interior volume 128 thereof. By providing the fuel bed in a suitable material which is at least partially transparent such interior illumination will be visible by a user located to the front of the fire. If the fuel bed is only supported at its perimeter it will be understood that the use of the partially transparent surface 127 may not be necessary in that there is no occluding surface between the light source and the fuel bed.

Flame generating means in the form of a moveable solid element 140 are provided between the light source 130 and the flame generating screen 115. The flame generating means are located forwardly of the screen 115. In this way light generated by the light source 130 will pass through the flame generating means 140 and be incident on a front surface 115a of the flame generating screen where it may be used to create the visual impression of one or more flames. The flame generating means 140 are operably used to modify the light passing therethrough so as to create a suitable flame pattern.

Movement of the flame generating means is effected by coupling the flame generating means to a motor 150, activation of which effects movement of the solid element that forms the flame generating means. As the solid element moves, it causes a break in the light being transmitted onto the screen, thereby causing flicker effects on the screen 115.

As shown in FIG. 1, the moveable solid element which forms the flame generating means may comprise a moveable baffle having a plurality of slits 145 provided therein. Desirably the baffle is rotatable and the rotation of the baffle effectively moves the slits in and out of the transmission path between the light source and the screen. When the slits occlude the light path there is a corresponding absence of light on the screen, when they are in the light path, the light generated by the light source may pass through the slits and onto the screen to generate a lighting effect on the screen. The periodic change in intensity of light incident on the screen creates flicker effects. Desirably the slits have a length 146 and a width 147 and are arranged on the baffle such that the length extends substantially transverse to the axis of rotation A-A′ of the baffle. In this way the rotation of the baffle gradually increases and then decreases the intensity of light seen on the screen.

Desirably the moveable baffle is provided in a cylindrical configuration with the light source being provided within the cylinder. Typically in such arrangements the light source will be arranged to extend along the longitudinal axis of the cylinder.

A mask 170 may be provided between the moveable solid element and the screen, the mask having a flame template 175 provided therein such that operably light passing through the mask will adopt the mask pattern to create a desired flame pattern, corresponding substantially with the pattern of the flame template.

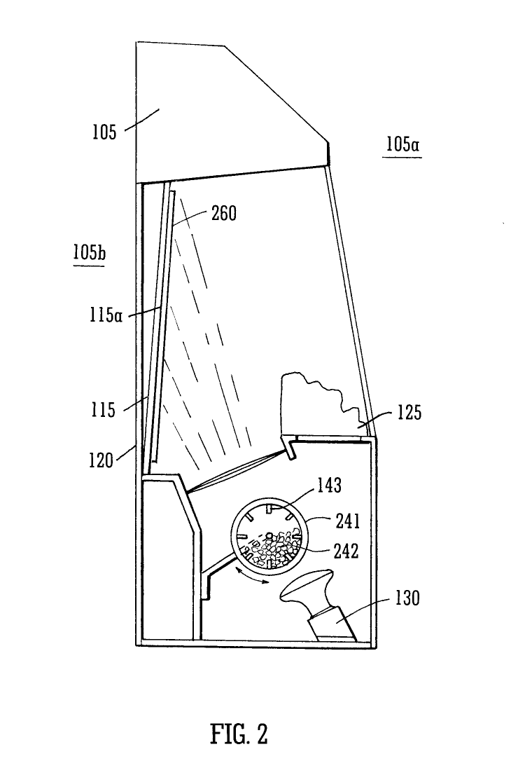

In the example of FIG. 2 the flame generating means comprises a container 241 at least partially filled with a plurality of solid elements 242. Typically the container will be at most half filled to allow for free movement of the solid elements within the container. Examples of the type of solid elements or bodies that could be usefully employed include coloured or at least partially transparent glass beads, plastic balls, sand, polystyrene bodies or the like. In this arrangement the movement of the container 241 is effected by having the container 242 rotatable about an axis that is parallel to the front of the fire. Rotation of the container 241 will cause the bodies 242 within the container to move which will operably affect the transmission of light through the container. One or more projections 243 may be provided on an inner surface of the container and as the bodies 242 are incident on the projections 243, their movement within the container is altered. The container is coupled to a motor and while rotation is described any suitable movement of the container could suffice to impart the necessary movement to the solid elements.

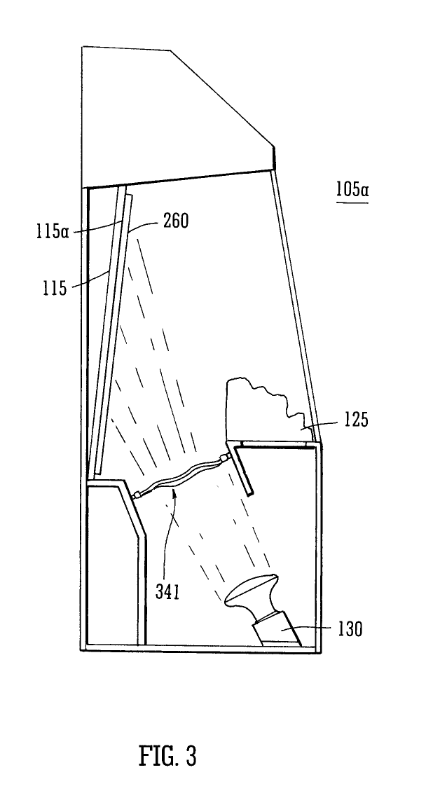

As shown in FIG. 3, the flame generating means are in the form of a number of fabric ribbons 341. The ribbons are arranged to at least partially occlude the light path between the light source 130 and the front surface 115a of the flame generating screen. The ribbons may be moveable, the movement of which will effect a disruption to the light passing therethrough, this disruption being visible in the form of a movement of flames on the screen 115. While ribbons have been employed before within the context of simulated fires, heretofore they have not been employed in a configuration where they are located forwardly of the flame generating screen. Neither has the movement been induced by a motor, rather air currents were used to generate the movement of the ribbons.

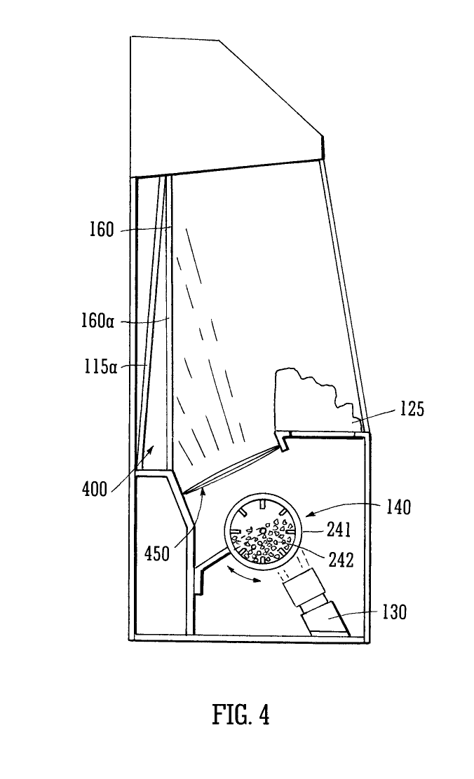

As is evident in FIGS. 2 and 3, and it will be appreciated that the schematic shown is not to scale, the screen 115 may be provided with an at least partially reflective surface 260 to the front such that a reflected image of the fuel bed 125 that is located to the front of the fire will be viewable off this at least partially reflective surface. The generated flame pattern will appear to a person located to the front of the fire to originate from a mid portion of the fuel bed, thereby enhancing the optical effect of the flame effect generated. It is possible to provide the partially reflective surface in the form or two or more screens in which case if provided as two screens, the partially reflective screen 260 may be provided so that it abuts the front surface 115a of the screen (as is shown in FIGS. 2 and 3) or could be located forwardly of the flame generating screen 115 (as is shown in FIG. 4). In such a latter arrangement, a gap 400 may be provided between the front surface 115a of the flame generating screen and an inner surface 160a of the partially reflective screen.

FIG. 4 shows an example of how the arrangement of FIG. 2 could be modified to include at least one lens 450 to be provided between the flame generating means 140 and the screen 115. The lens provides for a focusing of the light that has passed through the flame generating means 140 onto specific portions of the screen 115. The lens provides an exemplary flame focusing means and it will be appreciated that other optical arrangements that provide for a focusing of light onto the screen could also be used. If the flame focusing means is implemented using one or more lenses it is desirable that the lenses are of the type known as convex lenses. Their focal length is such that the parallel light that passes through the flame generating means is then focused onto specific regions of the flame generating screen 115. It will be understood that level of focusing achieved will depend on the distances between the lenses and the screen and the optical properties, for example the focal length, of the lens. While shown schematically as a single convex lens, other optical arrangements could be used, and such modifications will be apparent to the person skilled in the art. By using a lens arrangement that provides for a selective illumination of portions of the flame generating screen it is possible to generate individual flames within the flame pattern. It is also possible, though not shown for the light to be focused prior to incidence through the flame generating means. Such focusing could be provided by having the light source 130 provided with an integral lens system or by providing a separate lens arrangement between the flame generating means and the light source

While it is possible to illuminate the flame generating means 140 with a single light source, a plurality of light sources may be provided, each being selectively directed onto different portions of the cylinder that forms portion of the flame generating means. The light that passes through the cylinder may then pass through a selected one of a plurality of lenses each of which are configured to optically direct the light onto specific portions of the flame generating screen so as to generate images of individual flames. By judiciously choosing the optical properties and orientation of each of the lenses it is possible to arrange for different ones of the flames to have different dimensions—be that width and/or height. It will be appreciated that individual lenses could be related to a specific flame and in this exemplary arrangement there would be a 1:1 relationship between the two. In such a circumstance if one wanted to create for example 5 flames, then 5 lenses would be provided.

By providing a plurality of individual light sources the light output from each of the light sources can be individually varied such that selective portions of the screen 115 can be simultaneously illuminated with different colours. This may be advantageously provided by including one or more multicoloured light emitting diodes (LEDs) within the light source arrangement whose colour output can be varied depending on application of a suitable control signal. Alternative methodologies using for example mechanical filters could be used but the colour variability using such LED's makes them a preferred choice if colour variation is required.

As the moveable solid elements move a corresponding change in the light intensity of the light being transmitted through the solid elements will result. The nature of the movement is such as to create flicker effects in the displayed pattern. While the lenses will serve to selectively illuminate portions of the flame generating screen so as to create the impression of individual flames, the flame generating means creates the required flicker effect that one would expect from convention combustion of a fuel.

Referring back to FIG. 4, it will be appreciated that the flicker effect that is transmitted into the light passing through the cylinder may also be used to generate a flicker effect in the fuel bed. As the underside of the fuel bed is within the light path of the light passing outwardly from the cylinder it too will be illuminated differently depending on the rotation of the cylinder.

It will be appreciated that what has been described herein is an exemplary arrangement of an electric fire that includes a flame generator located forwardly of a flame generating screen so as to provide for light modified by the flame generator to be incident on a front surface of a flame generating screen. No liquid is employed in the generation of the flicker effect and movement of the flame generator effects a break in transmission of light incident onto a screen.

A lens arrangement may optionally be provided to provide for the generation of individual flames within a flame pattern. The orientation and optical parameters of individual ones of the lens arrangement may be used to selectively change the shape and height of the displayed flames. By using multicoloured light sources it is possible to also change the colour sequences of the displayed flame pattern over time. It will be appreciated that while the lenses have been described as being arranged between the solid element and the screen that if the lenses are arranged between the light source and the solid elements that specific targeting of light onto the moveable solid element could be achieved which would result in a corresponding selective illumination of the. Within this context the lenses could be arranged on either or both sides of the moveable solid elements. Furthermore two or more lenses could be arranged relative to one another to form a compound lens arrangement. While it may be advantageous to employ a 1:1 relationship between specific lenses and specific flames within the flame pattern it is possible that a single lens could be used in the formation of a plurality of flames, or that multiple lenses could be used in the formation of a single flame.

Furthermore single lighting elements could be used in the formation of single or multiple flames and multiple lighting elements could be used in the formation of single or multiple flames.

The words comprises/comprising when used in this specification are to specify the presence of stated features, integers, steps or components but does not preclude the presence or addition of one or more other features, integers, steps, components or groups thereof.

1. An electric fire comprising:
a. A light source;
b. A screen;
c. At least one moveable solid element provided forwardly of the screen and between the screen and the light source,
d. Mechanical actuating means for imparting movement to the at least one solid element, and
wherein operably light emitted from the light source is incident on the at least one moveable solid element prior to incidence on the screen, the movement of the solid element interrupting the light path between the light source and the screen and effecting generation of flicker effects within a generated flame pattern on the screen, and wherein a liquid does not contribute to the generation of the flame pattern.

2. The fire of claim 1 wherein the moveable solid element comprises a moveable baffle having a plurality of slits defined therein.

3. The fire of claim 2 wherein the baffle is provided in a cylindrical configuration, the light source being provided within the cylinder.

4. The fire of claim 3 wherein the baffle is rotatable about the light source.

5. The fire of claim 1 comprising a plurality of moveable solid elements provided within a container.

6. The fire of claim 5 wherein the container is sealed.

7. The fire of claim 5 wherein the container is moveable, movement of the container imparting movement to the moveable solid elements therein.

8. The fire of claim 5 wherein the container is stationary, the actuating means imparting movement to the moveable solid elements so as to effect relative movement between the container and the moveable elements therein.

9. The fire of claim 5 wherein the moveable elements are selected from coloured or at least partially transparent glass beads, plastic balls, sand, polystyrene bodies or the like.

10. The fire of claim 1 wherein the at least one moveable solid element comprises a plurality of moveable ribbons, the actuating means comprising a motor configured to induce movement to the moveable ribbons.

11. The fire of claim 1 comprising at least one lens located between the light source and the screen such that light from the light source is focused so as to selectively direct the light onto the screen.

12. The fire of claim 11 wherein the at least one lens provides for generation of individual flames on the flame generating screen.

13. The fire of claim 11 wherein the at least one lens is provided between the at least one moveable solid element and the screen.

14. The fire of claim 11 comprising at least one lens located between the light source and the at least one moveable solid element.

15. The fire of claim 11 wherein a plurality of lenses are provided, individual ones of the plurality of lenses being associated with an individual generated flame within the flame pattern.

16. The fire of claim 11 wherein the orientation and/or optical properties of individual lenses is selectable to change the dimensions of the generated flames.

17. The fire of claim 11 comprising a plurality of lenses arranged in a compound lens arrangement.

18. The fire of claim 1 wherein the light source comprises a plurality of lighting elements.

19. The fire of claim 18 wherein output colour of at least a portion of the plurality of lighting elements is varied to as to enable a selective colouring of the generated flame pattern.

20. The fire of claim 1 including a fuel bed located to the front of the fire and forwardly of the screen.

21. The fire of claim 19 wherein the at least one moveable solid element is provided relative to the fuel bed to effect generation of a flicker effect within the fuel bed.

22. The fire of claim 1 comprising a mask provided between the at least one moveable solid element and the screen, the mask having a fire pattern template provided therein, such that light passing through the mask and onto the screen will adopt the pattern of the template.

23. The fire of claim 1 wherein the screen includes an at least partially reflective surface.

24. The fire of claim 1 comprising a second screen provided to the front of the screen on which the flame pattern is generated, the second screen being at least partially transparent to allow light from the light source to pass through the second screen and onto the screen on which the flame pattern is generated.

25. The fire of claim 23 wherein the second screen comprises an at least partially reflective surface.

26. The fire of claim 1 wherein the mechanical actuating means comprises a motor.

27. The fire of claim 1 wherein the at least one moveable element is provided in the direct light path between the light source and the screen.

28. An electric fire comprising:
a. A screen on which a flame pattern may be generated;
b. A light source;
c. A moveable baffle having a plurality of apertures provided therein, the baffle being moveable relative to the light source, movement of the baffle effecting a break in the transmission path between the light source and the screen to generate flicker effects within a generated flame pattern, and
wherein the moveable baffle is provided to the front of the screen and between the screen and the light source, such that operably light emitted from the light source passes through the baffle and onto a front surface of the flame generating screen.

29. (canceled)
